(19) United States
(12) Patent Application Publication
(10) Pub. No.: US 2010/0037844 A1
(43) Pub. Date: Feb. 18, 2010

(54) CYLINDER HEAD AND ROCKER ARM ASSEMBLY FOR INTERNAL COMBUSTION ENGINE

(76) Inventors: Dan Kinsey, Lafarge, WI (US); Eric Orvis Wangen, Viroqua, WI (US); Scott Sjovall, Westby, WI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/540,023

(22) Filed: Aug. 12, 2009

Related U.S. Application Data
(60) Provisional application No. 61/136,126, filed on Aug. 13, 2008.

(51) Int. Cl. F01L 1/18; F02F 1/42

(52) U.S. Cl. 123/90.39; 123/193.5

(57) ABSTRACT

A cylinder head for an internal combustion engine includes at least one rocker arm assembly for an internal combustion engine is disclosed comprising a rocker arm cradle, a rocker shaft, and a rocker arm. The cradle adds design flexibility since it can be mounted in different orientations based on functional requirements of the engine, yet good rocker arm operation is maintained. Also, the engine includes a cylinder head that contains an air cooling passage and an improved oil distribution system.

### CROSS REFERENCE TO RELATED APPLICATIONS

This application claims benefit 35 U.S.C. §119(e) of provisional application Ser. No. 61/136,126, filed Aug. 13, 2008, entitled CYLINDER HEAD AND ROCKER ARM ASSEMBLY FOR INTERNAL COMBUSTION ENGINE, the entire contents of which are incorporated herein by reference.

### BACKGROUND OF THE INVENTION

The invention relates to engine components, and more particularly to cylinder head and valve train components for internal combustion engines.

It is desirable to control cylinder head temperature when operating an internal combustion engine. In an air-cooled engine, the cylinder head is cooled by air passing over its external surfaces and by the circulation of lubricating oil within the engine.

Reducing the temperature of the cylinder head may result in improved engine performance. As charge air passes from an induction system into the cylinder, heat is transferred to the charge air by the high temperature cylinder head. As the intake air temperature increases, so does the specific volume of the air. Thus, less air is admitted to the cylinder and less power is produced. Conversely, by decreasing the charge air temperature, additional air mass is admitted to the cylinder. By maintaining a stoichiometric air-fuel mixture, more fuel is oxidized and increased power output from the engine is achieved. In addition, controlling the cylinder head's temperature can avoid oil degradation and viscosity breakdown.

In engines having pushrod configurations, oil may be circulated from the crankcase to the cylinder head through pushrod assemblies. Once in the cylinder head, the oil lubricates the valve train components and absorbs excess heat from metallic surfaces before returning to the crankcase through a drainage system. As the oil circulates through the engine, it assists in conveying combustion heat to various engine surfaces thereby assisting with heat dissipation. Thus, a properly functioning oil system helps ensure that engine components do not overheat and fail. For instance, the combustion chamber and surrounding components witness extremely high temperatures during engine operation. If an oiling system is poorly configured and oil is permitted to pool in the cylinder head, the oil will be unable to effectively transfer heat away from the cylinder head and hot spots will likely occur. These hot spots may result in the formation of carbon deposits along the upper surface of the cylinder head. Because carbon deposits reduce the thermal conductivity of the cylinder head, heat dissipation inadequacies are further compounded, and the potential for component failure increases.

In addition to controlling cylinder head temperatures, it is also desirable to improve rocker arm assemblies in internal combustion engines. Reducing the complexity of the rocker arm assembly may lead to increased ease of assembly. In addition, potential cost reductions may be realized due to fewer components and fewer manufacturing processes. However, in addition to reducing complexity, it is also necessary to maintain or exceed current levels of strength and durability of the rocker arm assemblies, as well as flexibility to adapt to new valve train designs.

Accordingly, there is a need for a cylinder head design with improved heat dissipation capabilities. This need extends to both improved air cooling and improved oil distribution. There is also a need for a rocker arm system, disposed within a cylinder head, having simplified manufacturing and assembly requirements and improved strength and durability.

### SUMMARY OF THE INVENTION

A rocker arm assembly includes a rocker arm cradle, a rocker shaft, and a rocker arm. The rocker arm cradle is fastened to elevated mounting surfaces located on the upper surface of the cylinder head. The rocker arm cradle contains a first vertical upright portion containing a first hole and a second vertical upright portion containing a second hole. The rocker shaft extends between the first hole and the second hole. The rocker shaft extends between the first hole and the second hole of the rocker arm cradle and through the rocker arm. The rocker arm is free to rotate about the rocker shaft axis, thus permitting it to convey forces from a push rod to a valve stem.

In one aspect of the present invention, a rocker arm assembly for an internal combustion engine includes a rocker arm cradle having a base, a first vertical upright portion containing a first hole, and a second vertical upright portion containing a second hole. A rocker shaft engages and extends between the first and second holes. A rocker arm is rotatably mounted on the rocker shaft.

In another aspect of the present invention, a cylinder head assembly for an internal combustion engine includes a cylinder head having at least one elevated mounting surface. A rocker arm cradle has a base mounted to the at least one elevated mounting surface, a first vertical upright portion containing a first hole, and a second vertical upright portion containing a second hole. A rocker shaft extends between the first and second holes. A rocker arm is rotatably mounted on the rocker shaft.

An object is to provide a robust and durable rocker arm assembly that is design-flexible for use in new and different valve train designs.

Also, in another aspect, a cylinder head for an internal combustion engine is disclosed. The cylinder head contains a cooling passage located between a combustion chamber and an upper surface of the cylinder head. In addition, the cylinder head contains an oil distribution system which controls cylinder head temperature and reduces the potential for oil leakage near a gasket.

These and other features, advantages and objects of the present invention will be further understood and appreciated by those skilled in the art by reference to the following specification, claims and appended drawings.

### BRIEF DESCRIPTION OF THE DRAWINGS

FIGS. 1 and 2 are side and exploded/perspective views of an internal combustion engine.

FIG. 2 is an exploded view of a cylinder head assembly.

FIG. 3 is a top view of the cylinder head shown in FIG. 2, the cover being removed.

FIG. 4 is a cross-sectional view taken along line IV-IV of FIG. 3.

FIGS. 5A-5C are side cross-sectional views of an example cylinder head, each including a different modified cooling passage.

FIG. 6 is an exploded perspective view of a rocker arm assembly.

FIG. 7 is a top view of a rocker arm assembly like FIG. 6.

FIGS. 8-11 are side cross-sectional views of example cylinder heads with a base of the present rocker arm system attached/supported at different orientations.

FIG. 12 is a perspective view showing a 6-bore modified cylinder head incorporating the present rocker arm system.

### DETAILED DESCRIPTION OF PREFERRED EMBODIMENT

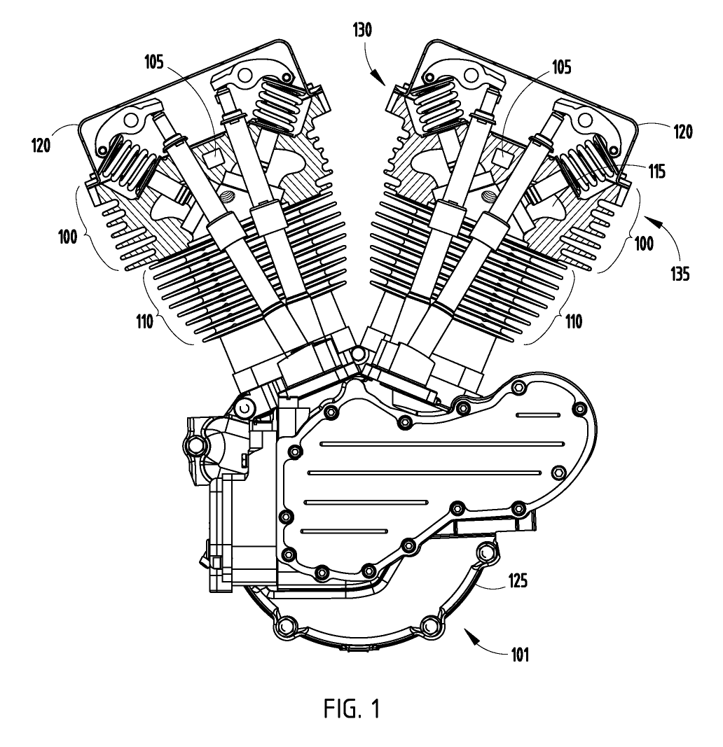

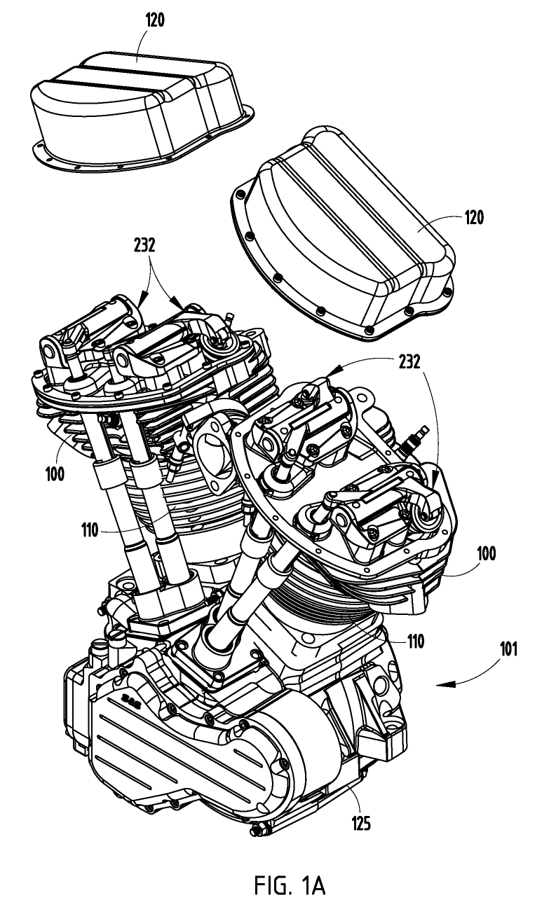

FIGS. 1-1A illustrate a motorcycle engine 101 comprising a crankcase 125, cylinders 110, cylinder heads 100, and rocker arm covers 120. Those skilled in the art will recognize that the implementations described herein are not limited to engine applications for motorcycles. Accordingly, the implementations described herein may be used in a variety of motor vehicle applications (e.g., all-terrain vehicles, go-carts, snowmobiles, etc.) as well as stationary engine applications (e.g., generators, pumps, etc.).

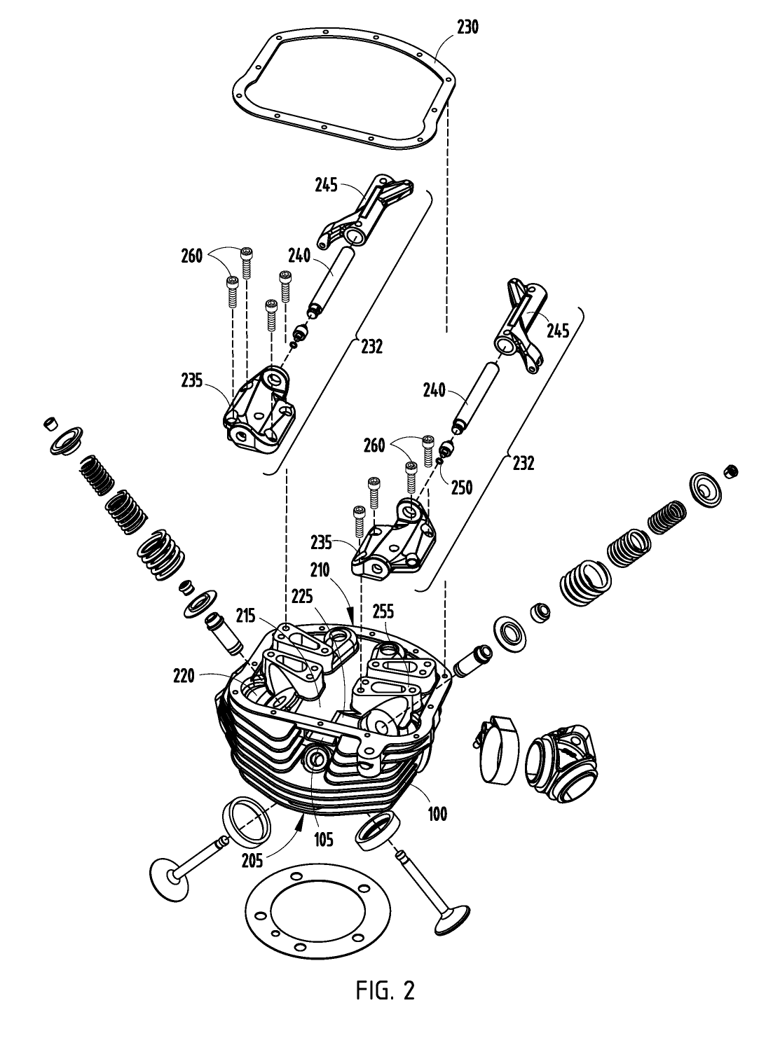

FIG. 2 shows an exploded view of a cylinder head assembly. The cylinder head 100 may be comprised of aluminum, steel, or other suitable materials (e.g., aluminum alloys, magnesium, etc.). The cylinder head 100 may be formed by casting, forging, machining, or other suitable manufacturing processes.

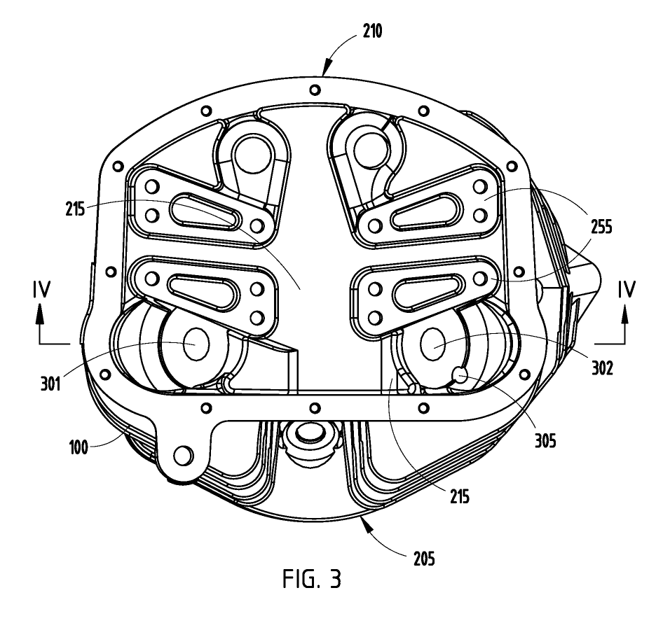

FIG. 3 shows a top view of the cylinder head shown in FIG. 2. An intake valve location 301 and exhaust valve location 302 are located near the first side 205 of the cylinder head 100. An oil drain hole 305 is located near the exhaust valve location 302. The oil drain hole 305 is connected to a passage leading back to the crankcase 125. When arranged in a common V configuration, a cylinder bank 110 may be positioned between 22.5 and 45 degrees from vertical with the exhaust port 115 facing outwardly as shown in FIG. 1. In this configuration, the intake manifold will connect to the higher side 130 and the exhaust manifold will connect to the lower side 135. As shown in FIG. 2, the cylinder head 100 is substantially flat across an upper surface 215 with the exception of depressions near the intake and exhaust valve locations 225, 220. When the engine 101 is assembled and the cylinder head 100 is positioned at an angle, the flat geometry of the upper surface 215 of the cylinder head 100 permits lubricating oil to drain back to the crankcase 125 via the oil drain hole positioned near the exhaust valve location 302. Thus, oil pooling along the upper surface 215 of the cylinder head 100 is reduced, and the potential for hot spots or oil leakage between the cylinder head 100 and a gasket 230 is decreased. The oil system thereby provides a constant flow of oil across the upper surface 215 of the cylinder head 100.

As shown in FIG. 2, a rectangular cooling channel 105 passes through the cylinder head 100. The cooling channel 105 may be round, oval, triangular, or any other suitable shape. The cooling channel may be formed in the cylinder head 100 during a casting process or may be created by a suitable machining process (e.g., milling, drilling, water jet drilling, laser drilling, etc.). The cooling channel 105 permits air to pass between a first side 205 and a second side 210 of the cylinder head 100, thereby dissipating heat from the cylinder head 100.

FIG. 4 shows a side cross-sectional view of FIG. 3 taken along line 4-4. The cross-sectional view displays the air cooling passage 105 which is located between the upper surface 215 of the cylinder head 100 and the combustion chamber 425. The air cooling passage 105 is located above the threaded hole 430 for the spark plug. Although the air cooling passage 105 is shown closer to the upper surface 215 than to the combustion chamber 425, this is not limiting. For example, the air cooling passage 105 may be positioned closer to the combustion chamber 425 than to the upper surface 215 of the cylinder head 100. The cooling channel 105 may have a constant cross-sectional area or a non-constant cross-sectional area.

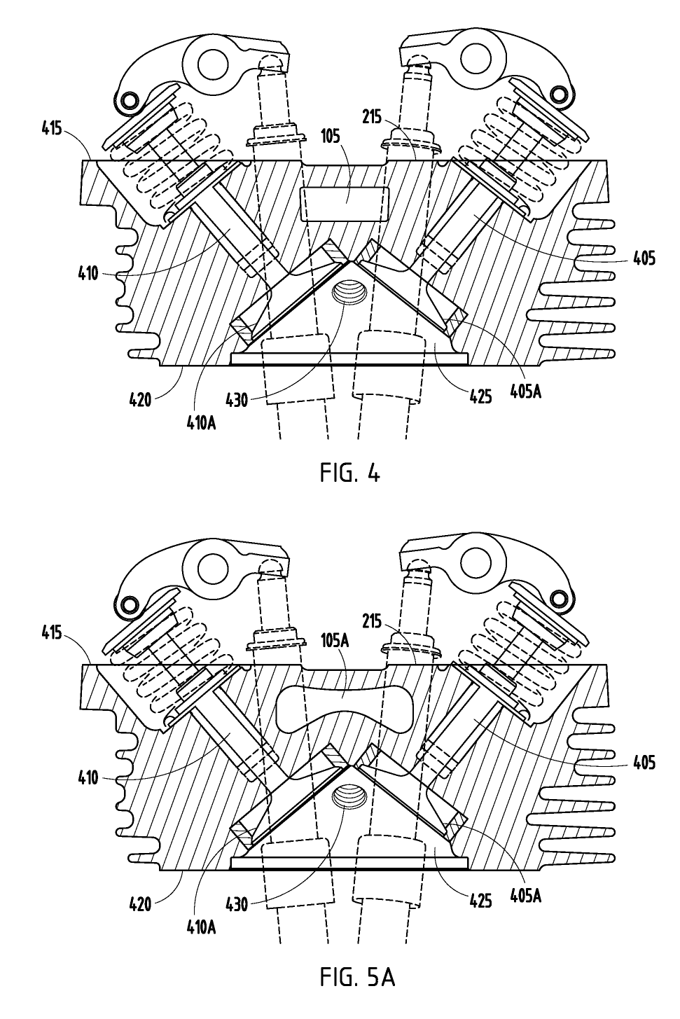

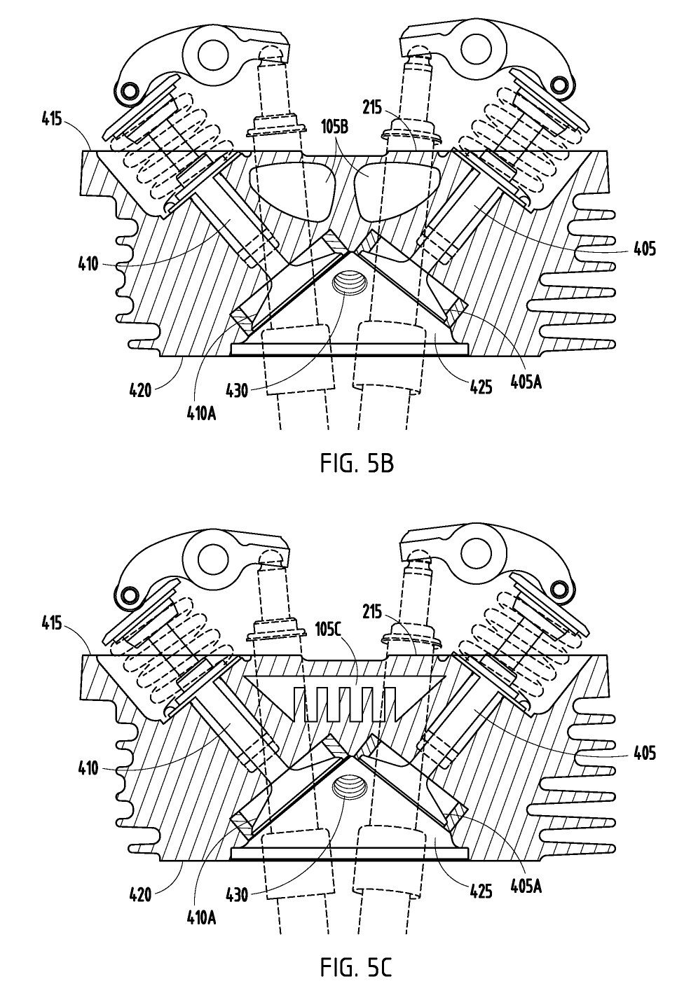

FIGS. 5A-5C show various implementations of the air cooling passage shown in FIG. 4. For example, FIG. 5A shows another suitable shape for the air cooling passage 105A. In addition to shape variations, the number of cooling passages may also vary. For example, FIG. 5B depicts a second air cooling passage 105B. The two cooling passages may be similar or dissimilar in shape. Also, as shown in FIG. 5C, the cooling channel 105C may contain cooling fins along an inner surface to increase heat dissipation through conduction, convection, and/or radiation. Further, the cylinder head 100 may contain an air directing portion which directs air through the cooling channel 105 when the engine 101 is attached to a moving motorcycle, thereby increasing the heat dissipation capabilities of the cooling passage.

The geometry of the engine valves in the cylinder head 100 is visible in FIG. 4. Both the intake valve 410 and exhaust valve 405 are oriented 40 degrees from a vertical plane containing the bore centerline. The valve seat is formed by a matching insert 410A and 405A. The illustrated cylinder head has a height of 3.25 inches measured from the upper mating surface 415 to the lower mating surface 420.

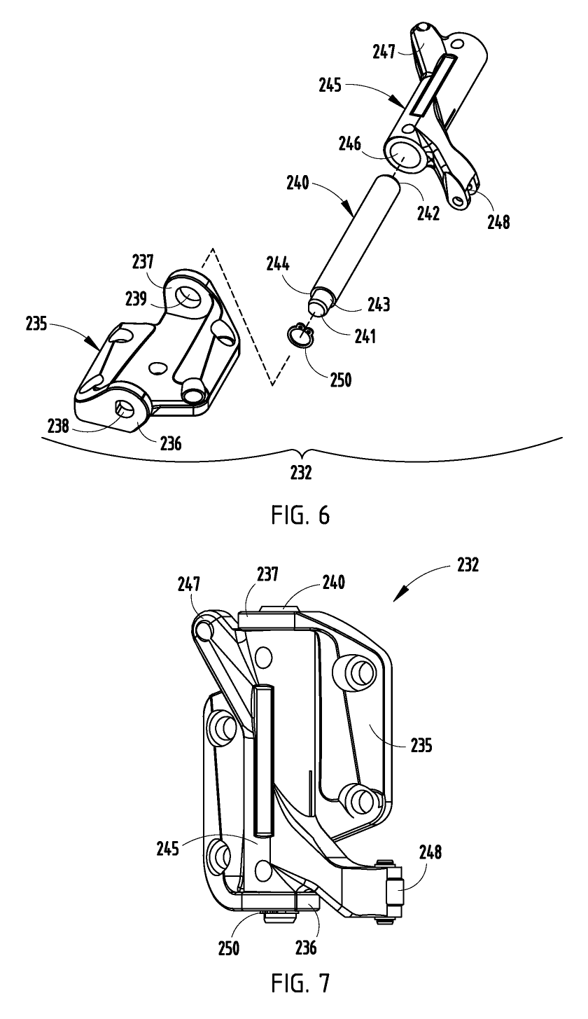

As shown in FIG. 6, the rocker arm system 232 is comprised of a rocker arm cradle 235, a rocker shaft 240, a rocker arm 245, and a snap ring 250. As depicted in FIG. 2, the rocker arm cradle 235 is fastened to two elevated mounting surfaces 255 located on the flat upper surface 215 of the cylinder head 100. Although two elevated surfaces are shown, a single elevated mounting surface may be used. On the other hand, more than two elevated mounting surfaces may also be used. Also the elevated mounting surfaces could be at different heights in two different engines, yet the same rocker arm assemblies could be used in both engines, even if the cylinder head configurations were different. Bolts 260′ or other suitable fasteners may be used to attach the rocker arm cradle 235 to the cylinder head 100. The bolt pattern in the base of the rocker arm cradle 235 has a parallelogram shape, best shown in FIG. 7. However, it is contemplated that the bolt pattern is not limited to this configuration.

As shown in FIG. 6, the rocker arm cradle 235 contains a first vertical upright portion 236 and a second vertical upright portion 237. The first vertical upright portion 236 contains a first hole 238 which passes through the upright portion 236. The second vertical upright portion 237 contains a second hole 239 which passes through the second upright portion 237. The first hole 238 is D-shaped while the second hole 239 is round. The rocker arm cradle 235 may be made of steel, aluminum, or other suitable materials.

A rocker shaft 240 contains a first end 241 and a second end 242. The illustrated first end 241 of the rocker shaft 240 is D-shaped, while the second end 242 is round. During assembly, the first end 241 of the rocker shaft 240 is inserted through the second hole 239 in the rocker arm cradle 235. The first end 241 then passes through a cylindrical hole 246 in the rocker arm 245 and finally through the first hole 238 in the rocker arm cradle 235. In the illustrated arrangement, the D-shaped mating surfaces of the first end 241 rotationally locks in the first hole 238, preventing the rocker shaft 240 from rotating. Other suitable anti-rotation features may be used. Once in place, a snap ring 250 is positioned over a groove 243 located at the first end 241 of the rocker shaft 240. The snap ring 250 and a rocker shaft shoulder 244 prevent the rocker shaft 240 from moving axially during engine operation. Other suitable axial retention features may be used. It is specifically contemplated that the rocker shaft 240 could be made so that both ends are round (i.e., like end 242), such as when the anti-rotation feature of the D-shaped end (241) is not needed.

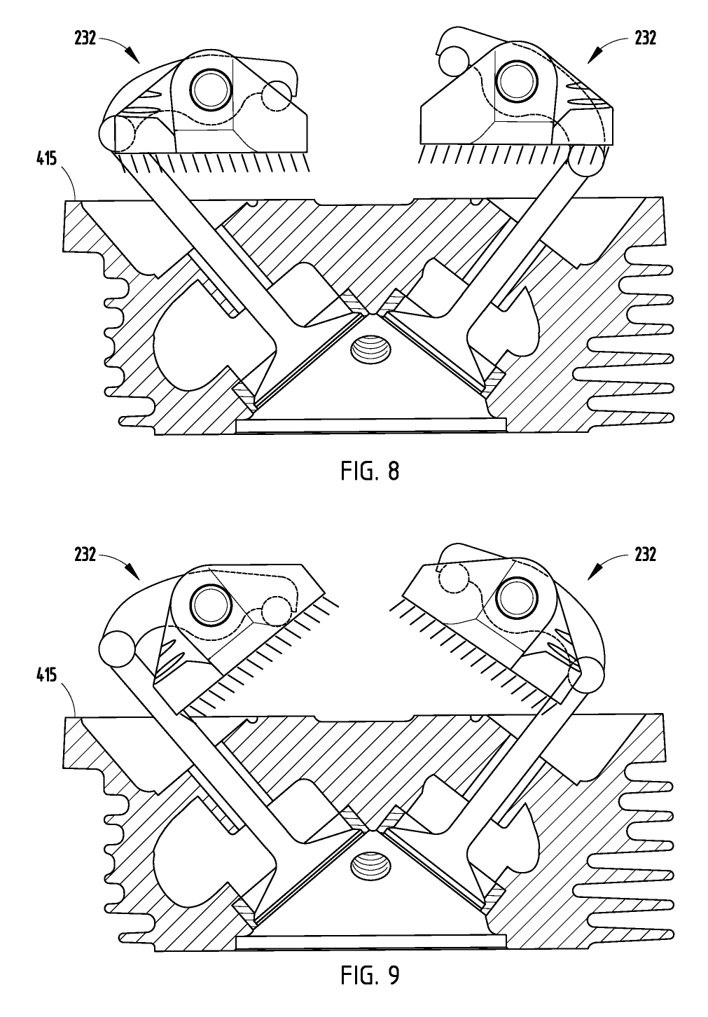

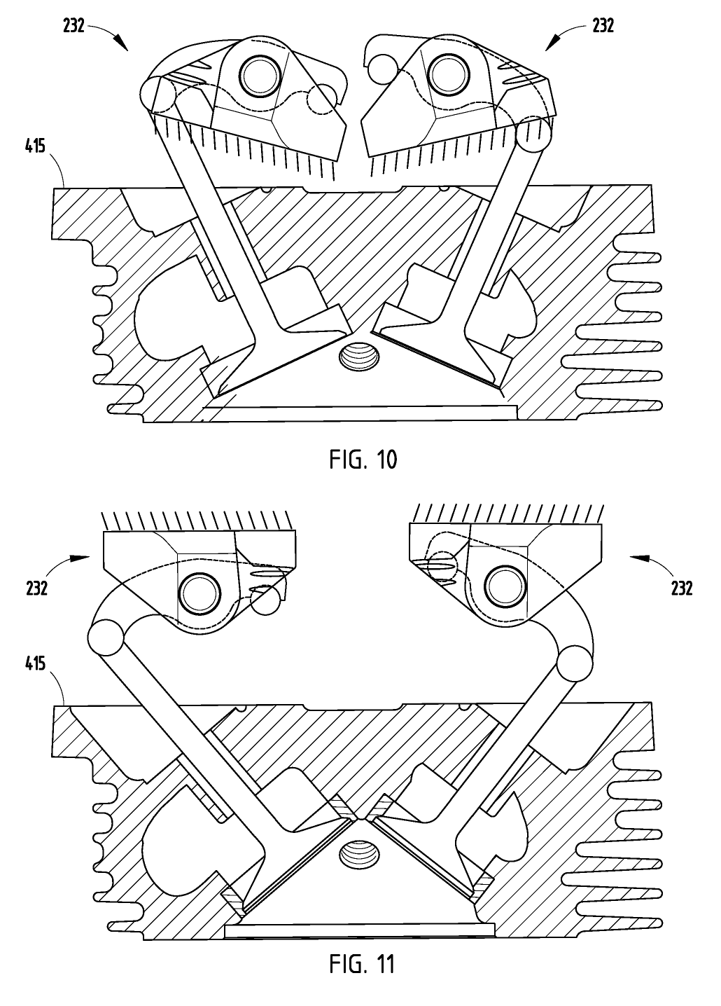

In other implementations, the orientation of the rocker assembly may be altered. (See FIGS. 8-11.) For example, the rocker arm cradle 235 may be rotated 180 degrees such that identical rocker arm systems 232 can be used on both sides of a two-cylinder engine. Alternatively, the rocker arm cradle 235 can be supported on a raised mounting surface parallel to a top of the cylinder head 415 (see FIGS. 2 and 8), or on an inward or outward angled mounting surface (FIGS. 9, 10), or inverted (FIG. 11). In such an implementation, the rocker shaft 240 may be inserted from the first side 205 of the cylinder head 100 towards the second side 210 of the cylinder head 100.

Once assembled, the rocker arm 245 is free to rotate around the axis of the rocker shaft 240. When fully assembled, as shown in FIG. 7, a pushrod will apply a force to a pushrod actuator portion 247 of the rocker arm 245 causing rotation of the rocker arm 245. Rotation of the rocker arm will cause a valve actuator portion 248 to apply downward force on the valve stem thereby opening the valve.

FIGS. 8-11 show that the present rocker arm system can be advantageously used in various mounted arrangements. FIG. 8 shows an arrangement like FIG. 4 where a flat bottom of the cradle 235 is mounted parallel but raised above a top of the cylinder head 215. FIGS. 9-10 are similar to FIG. 8, but FIGS. 9-10 show that the cradle 235 can be mounted at an angle if the engine requires it. FIG. 11 shows that the cradle 235 can even be mounted in an inverted position if necessary.

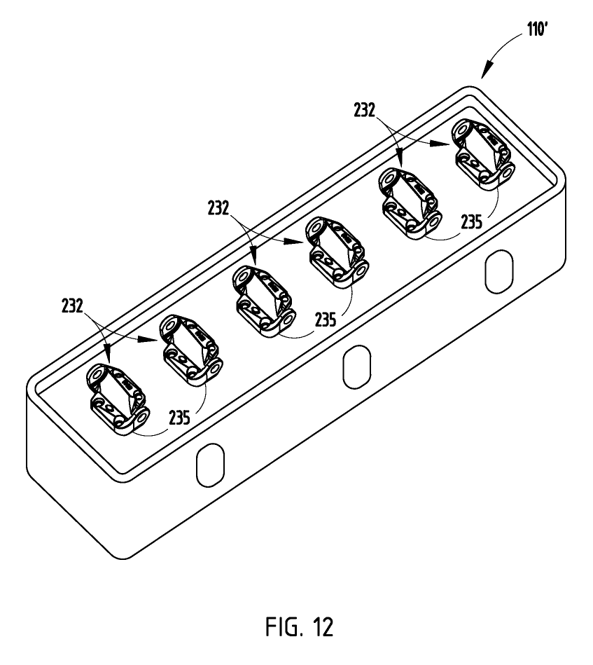

While a single rocker arm assembly is shown in FIG. 2, this is not limiting. There may be one or more rocker arm assemblies contained within the cylinder head assembly. Further, the disclosed rocker arm assembly may be used in conjunction with other rocker arm assemblies and/or other cylinder heads. For example, see FIG. 12 which illustrates an in-line six cylinder head 100′, such as could be used for more powerful and larger engines, such as for cars, trucks, other wheeled vehicles, boats, other non-wheeled vehicles, and power plants for non-vehicle applications, pumps, etc.

While an exemplary implementation is described, the present implementation can be further modified within the spirit and scope of the implementation. Thus, this application is intended to cover any variations, uses, or adaptations of the implementation using its general principles. Further, this application is intended to cover equivalents which fall within the limits of the appended claims.

The invention claimed is:

1. A rocker arm assembly for an internal combustion engine, comprising:
a rocker arm cradle having a base, a first vertical upright portion containing a first hole, and a second vertical upright portion containing a second hole;
a rocker shaft engaging and extending between the first and second holes; and
a rocker arm rotatably mounted on the rocker shaft.

2. The rocker arm assembly defined in claim 1, wherein the base includes a flat surface adapted for mounting to an elevated mounting surface on a cylinder head.

3. The rocker arm assembly defined in claim 1, wherein the rocker arm extends transverse to the rocker shaft and includes a first end configured to engage a push rod and a second end configured to engage an engine valve.

4. The rocker arm assembly defined in claim 3, wherein the first end of the rocker arm is located longitudinally along the rocker shaft from the second end.

5. The rocker arm assembly defined in claim 1, wherein the rocker shaft rotatably engages the first and second holes.

6. A cylinder head assembly for an internal combustion engine, comprising:
a cylinder head having at least one elevated mounting surface;
a rocker arm cradle having a base mounted to the at least one elevated mounting surface, a first vertical upright portion containing a first hole, and a second vertical upright portion containing a second hole;
a rocker shaft extending between the first and second holes; and
a rocker arm rotatably mounted on the rocker shaft.

7. The assembly defined in claim 6, wherein the base includes a flat surface mounted to one of the at least one elevated mounting surface on a cylinder head.

8. The assembly defined in claim 7, wherein the flat surface is located above a perimeter flange of the cylinder head.

9. The assembly defined in claim 7, wherein the flat surface is oriented at an angle to horizontal when mounted to the cylinder head.

10. The assembly defined in claim 6, wherein the rocker arm extends transverse to the rocker shaft and includes a first end configured to engage a push rod and a second end configured to engage an engine valve.

11. The assembly defined in claim 10, wherein the first end of the rocker arm is located longitudinally along the rocker shaft from the second end.

12. The assembly defined in claim 10, wherein a centerline of the rocker shaft is located above a line connecting bottom surfaces of the first and second ends.

13. The assembly defined in claim 6, wherein the rocker shaft rotatably engages the first and second holes.

14. The assembly defined in claim 6, wherein the rocker shaft non-rotatably engages the first and second holes.

15. The assembly defined in claim 6, wherein the cylinder head includes at least two of the elevated mounting surfaces, and further includes a cooling passageway extending through the cylinder head between the two elevated mounting surfaces and parallel the first rocker shaft and below the two elevated mounting surfaces.
